(19) United States
(12) Patent Application Publication
(10) Pub. No.: US 2006/0003075 A1
(43) Pub. Date: Jan. 5, 2006

(54) Method and apparatus for preparing a beverage

(76) Inventor: Keith J. Meador, Southlake, TX (US)

Correspondence Address: HARNESS, DICKEY & PIERCE, P.L.C., P.O. BOX 828, BLOOMFIELD HILLS, MI, 48303, US

(21) Appl. No.: 11/170,613

(22) Filed: Jun. 29, 2005

Related U.S. Application Data
(60) Provisional application No. 60/585,451, filed on Jul. 2, 2004.

(51) Int. Cl. C12C 1/00

(52) U.S. Cl. 426/590

(57) ABSTRACT

A method and apparatus for producing a beverage product. The beverage product may be produced by moving a solvent through a beverage ingredient package or moving an ingredient from a beverage ingredient package in a selected manner. The beverage ingredient package may be provided to produce an efficient beverage in a selected time period. The beverage ingredient package may be preformed and include a selected geometry to achieve various results.

### CROSS-REFERENCE TO RELATED APPLICATIONS

This application claims the benefit of U.S. Provisional Application No. 60/585,451, filed on Jul. 2, 2004. The disclosure of the above application is incorporated herein by reference.

### FIELD

This teachings relate a beverage apparatus and more particularly to an apparatus having a packaged beverage ingredient and/or water supply.

### INTRODUCTION

A beverage assembly or package can include a prepackaged set of ingredients or loose ingredients (coffee, tea, soluble product etc.) that are placed in a portions of a beverage apparatus. A maker or beverage apparatus can add water to the beverage assembly in a chamber that is designed to heat the water and cause the heated water to move relative to the beverage ingredients. The process of preparing a beverage can include: 1. opening a beverage chamber, 2. inserting a beverage ingredient, which may be a prepackaged mix or measuring the ingredients if not prepackaged, 3. adding a measured amount of water, 4. closing the beverage chamber, 5. placing a container to catch the beverage, and 6. operating the beverage apparatus.

To accomplish this or other processes to make a beverage, many different designs and operations of beverage apparatuses have been proposed. Many designs require both the placement of a beverage ingredient, such as coffee grounds, tea, a soluble product, or the like in the beverage apparatus and positioning a solvent in the beverage apparatus. This may require additional work and possible contamination. In addition, various steps, such as measuring the solvent, such as water, or the beverage ingredients may be faulty to various reasons.

Both the beverage ingredients and the solvent, such as water, can influence the quality and consistency of a produced beverage. Tap water is usually used for consumer beverage making. Tap water flavor varies depending on the treatment of the water and the region. Also the beverage ingredient generally is dependant upon a ratio to the solvent. Using the exact volume of water to a constant measurement of beverage ingredients is the only way to assure a consistent product and, yet, it is still vulnerable to the quality of the water and beverage ingredient.

Beverage ingredients, such as ground coffee is typically sold by weight in re-closeable cans and bags. The can or bag of coffee is typically vacuum-sealed and after opening oxygen begins to affect the quality of the coffee grounds. The freshest cup of coffee produced is after the coffee container is first opened and the quality can deteriorate thereafter.

### SUMMARY

A method and apparatus for forming a produced beverage or beverage in an efficient and selected manner. A beverage ingredient may be provided in a beverage package that is prepackaged, such as premeasured and contained, or in another selected manner. The beverage package generally allows for an efficient and quick production of a beverage at a selected time. The beverage package generally allows for the introduction of a solvent, such as water, at a selected position of the beverage package and allows the solvent to extract or mix with a beverage ingredient as the solvent passes through the beverage package to a second position relative to the beverage package. The beverage package may be provided in any appropriate apparatus for producing a selected beverage.

According to various embodiments, a beverage package may include a first dimension or area, such as internal area, and a second area or dimension, such as an external area or dimension. The internal area may allow for the introduction of a solvent relative to the beverage package. The external area may allow for the passing of a beverage solvent relative to the beverage package, or vice versa. The beverage solvent may pass through the package in a selected manner such as it is able to dissolve or extract a selected portion of the ingredient from the beverage package.

According to various embodiments, a beverage package may include a substantially toroidal shape defining an internal void. A beverage solvent may be introduced relative to the internal void of the beverage package and forced to pass through the beverage package to an external portion of the beverage package opposite the internal void, or vice versa. The beverage solvent is operable to extract a selected portion of the beverage ingredient to form a produced beverage.

According to various embodiments, the produced beverage may include an extracted ingredient or a dissolved ingredient. According to various embodiments, any appropriate ingredient may be placed in a beverage package for forming a produced beverage.

According to various embodiments, beverage ingredients and a beverage solvent, such as water, are pre-measured and contained in a cartridge. The beverage solvent and beverage ingredients may be sealed in separate compartments of the cartridge. According to various embodiments, both the solvent and the ingredients may be self contained in a single unit prior to forming a beverage.

According to various embodiments a piercing element is positioned to pierce the beverage package or beverage apparatus compartment to permit the passage or flow of a solvent from a portion of the beverage apparatus to a beverage making chamber.

According to various embodiments a beverage package can include a commercially available bottled water and a cap portion, which may house beverage ingredients. According to various embodiments a separate water cartridge and separate beverage ingredients cartridge can be utilized to permit a user to combine any beverage ingredient with any water cartridge or to heat water only.

Further areas of applicability of the present teachings will become apparent from the description provided hereinafter. It should be understood that the description and various examples, while indicating the various embodiments of the teachings, are intended for purposes of illustration only and are not intended to limit the scope of the teachings.

### BRIEF DESCRIPTION OF THE DRAWINGS

The present teachings will become more fully understood from the detailed description and the accompanying drawings, wherein:

FIG. 1 is a perspective view of a beverage ingredient package according to various embodiments;

FIG. 1A is a perspective view of a beverage ingredients package according to various embodiments;

FIG. 2 is a cross-sectional view of FIG. 1 taken along line 2-2;

FIG. 3 is a perspective view of beverage apparatus according to various embodiments;

FIG. 4 is a cross-sectional view of the beverage apparatus of FIG. 3;

FIG. 5 is a cross-sectional view of a beverage container according to various embodiments;

FIG. 6 is a cross-sectional view of a beverage container according to various embodiments;

FIG. 7 is a cross-sectional view of a beverage container according to various embodiments; and

FIG. 8 is a perspective view of an appliance to assist in forming a beverage according to various embodiments.

### DETAILED DESCRIPTION OF VARIOUS EMBODIMENTS

The following description of various embodiments is merely exemplary in nature and is in no way intended to limit the teachings, applications, or uses.

With reference to the figures, like reference numerals are used to reference like portions.

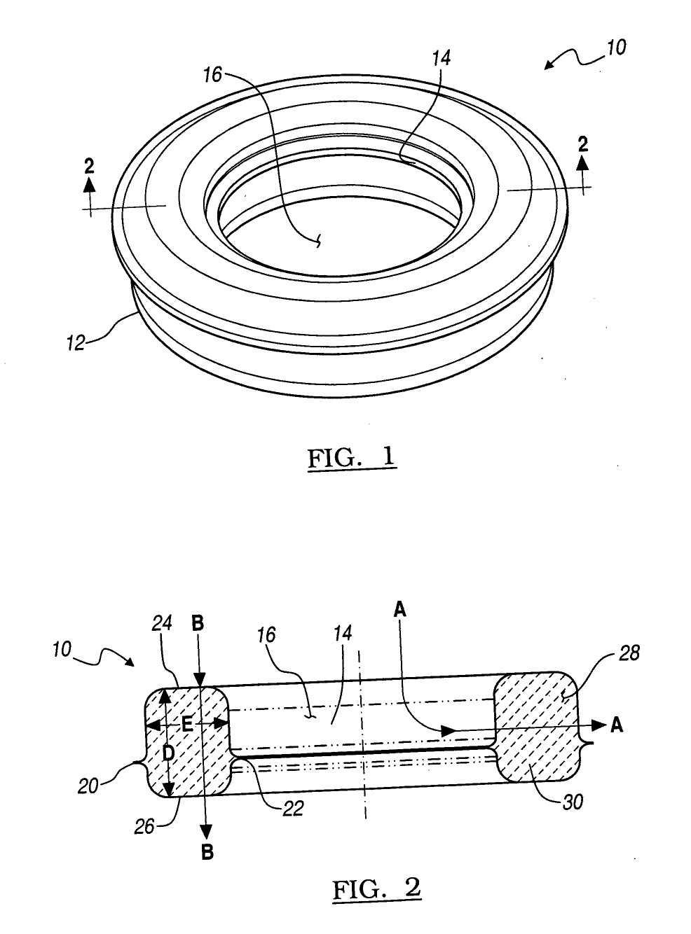

With reference to FIG. 1, a beverage ingredient package (BIP) 10 is illustrated. The BIP 10 may be formed in any appropriate shape or size. The BIP 10 may generally include a generally toroid shape including an outer wall 12 defining an outer diameter. In addition, the BIP 10 may include an internal wall 14 defining an internal diameter. Although the BIP 10 may be illustrated substantially as a toroid or cylindrical device, it will be understood that the BIP 10 may be formed in any appropriate manner. The BIP 10 may be formed in any appropriate shape, size, geometry, or the like. Generally, the BIP 10 includes an internal void 16 defined by the internal wall 14 which allows for introduction of a selected component relative to the BIP 10. The void 16 may not be present in various embodiments, and the introduction of a component may be altered accordingly.

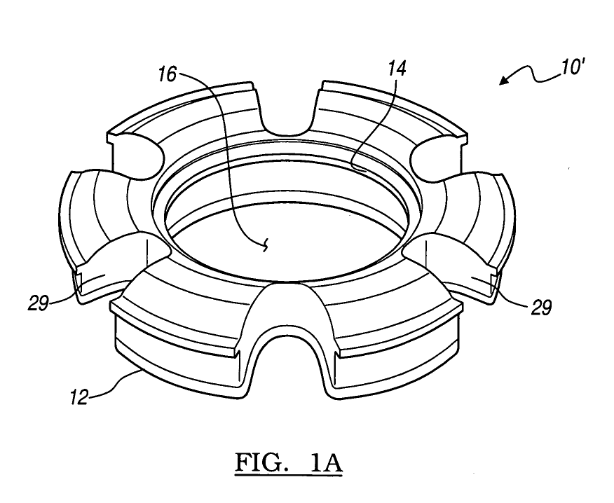

With continuing reference to FIG. 1 and additional reference to FIG. 2, the BIP 10 may be formed in any appropriate manner of any selected material. For example, the BIP 10 may be formed of a layer or multiple layers of a material that are formed together at a seal. The seal may include an external seal point 20 and an internal seal point 22. The seal points 20, 22 may be substantially concentric and be a portion of the external wall 12 and the internal wall 14. Therefore, the BIP 10 may be formed of a top or first layer 24 and a bottom or second layer 26 that are sealed together at the seal points 20, 22. Nevertheless, it will be understood that the BIP 10 may be formed of a substantially single piece of material that is sealed or connected as selected area. For example, a large piece of material may be folded over itself and sealed at a selected area such that only a partial seal is necessary rather than a complete seal around the walls 12, 14.

The material for the layers 24, 26 may be any appropriate material. According to various embodiments, a solvent may be positioned relative to the BIP 10, therefore, the material for the layers 24, 26 may be selected to be generally porous to the solvent. The layers 24, 26, therefore, may include papers, polymers, natural or synthetic materials, or any appropriate material. For example, weldable paper, such as that sold by CASCADEC a Glaffelter company, may be used as the layers 24, 26 to form the BIP 10. Regardless of the material selected to form the layers 24, 26, the layers 24, 26 may be positioned such that they may be sealed or welded at the seal points 20, 22.

The BIP 10 may be formed in any appropriate manner. According to various embodiments, as discussed above, the BIP 10 may include a top portion or member 24 and a bottom portion member 26 that are substantially welded or adhered together at a seam 20, 22. The welding may be formed by a heat weldable paper or may include a bonding ingredient that is provided between the two portions 24, 26. In addition, as discussed above, the BIP 10 may include a single member that is folded over itself or folded around the beverage ingredient 30 and sealed in appropriate regions to form a substantially sealed BIP 10. In the BIP 10 the first member or portion 24 and the second portion 26 are generally porous to the selected solvent. Therefore, the solvent may enter the inner or toroidal void 16 and pass through the internal void 28 defined by the BIP 10 substantially in the direction of arrow A or any appropriate manner.

The BIP 10 may include an internal area or pocket 28, which may also be referred to as a containment area, that is defined by the sealed or welded layers 24, 26. The containment area 28 of the BIP 10 may be used to contain any selected beverage ingredient 30, as discussed herein. Regardless, the beverage ingredient or material 30 may be positioned in the BIP 10 for a use of the BIP 10. As discussed herein, the beverage ingredient 30 may be positioned in the BIP 10 such that a solvent may pass through the layers 24, 26 to interact with the beverage ingredient 30 to produce a produced beverage.

A BIP 10′, with reference to FIG. 1A, according to various embodiments, may also be formed in various selected manners. For example, the BIP 10′ may be formed as a toroid including void areas 29. That is the containment area 28 need not be uniform around the BIP 10′. This may be selected for various purposes, such as selected beverages and/or selected dilutions. As discussed herein, the void areas 29 in the BIP 10′ may allow a selected volume of the solvent to move passed the BIP 10′ without contacting the ingredient 30. It will be understood that the voids 29 may be formed in any manner and need not be limited to depressions extending from the outside, but may also be depressions from the top and bottom or merely internal areas not including any of the beverage ingredient.

According to various embodiments, a solvent may be applied to a surface of the BIP 10 from the central void 16 in the direction of arrow A. The solvent, which may be a fluid such as water, may pass through the inner wall 14 through the inner compartment 28, including the beverage ingredient 30, and pass out the outer wall 12 generally in the direction of arrow A. Therefore, the solvent is operable to move from a first region, such as the internal void 16, of the BIP 10 to a second region of the BIP 10, such as out the exterior wall 12.

It will be understood that the solvent or any appropriate material may be introduced relative to a BIP 10 and exit the BIP 10 in any appropriate manner. For example, a material, such as solvent, may also pass substantially axially through the BIP 10 generally in the direction of arrow B. The solvent may pass generally axially in the direction of arrow B through the BIP 10 for selected purposes. For example, the solvent may be positioned to cover a substantial area of the BIP 10 such that a selected dilution of the ingredient 30 in the BIP 10 is obtained.

In addition, the solvent may move generally in the opposite direction of arrow A. The solvent may enter through the outside wall 12 and be dispensed through the internal void 16. Therefore, it will be understood that the solvent may be introduced and pass through the BIP 10 in any appropriate manner, according to various purposes. Nevertheless, the solvent may pass through the BIP 10 to allow for an extraction or forming a solution of the ingredient 30 that is positioned relative to the BIP 10.

In addition, the BIP 10 may include any appropriate cross-section or area. For example, the BIP 10 may define the area 28 to include a first dimension D and a second dimension E. The two dimensions, D, E, may define an area such as a cross-sectional area of the portion of the BIP 10. The dimensions D, E may be any appropriate dimensions and may include a single dimension, for example if the internal area 28 is substantially circular. Nevertheless, the various dimensions D, E may be varied to produce the BIP 10 to include a selected volume, a selected contact area between the solvent and the ingredient 30 in the interior area 28, or any other appropriate reason. For example, increasing the dimension D, E may increase the surface area which the solvent is able to contact during a production of a beverage. Therefore, it will be understood that the dimensions D, E or any other appropriate dimensions may be selected based upon various aspects.

The solvent, such as water, can be passed through the BIP 10 in any appropriate manner. For example, a pressure differential may be created across the BIP 10 such that the solvent is urged to flow from a first position to a second position. For example, the solvent may be introduced into the internal void 16 at a pressure higher than a pressure near the outer wall 12. Therefore, the water, because the layers 24, 26 are generally porous to the solvent, the solvent may flow from the internal void 16 out through the external wall 12. Nevertheless, the pressure differential may also be provided between the outer wall 12 and the internal void 16 such that solvent may flow from the outer wall 12 toward the internal void 16.

Also, the pressure differentials may be formed in any appropriate manner. For example, the solvent may be provided at a pressure higher than that in the BIP 10 to an area containing the BIP 10. In addition, an area containing the BIP 10 may be formed to produce the pressure differentials. Alternatively, or in addition, the force of gravity may be used to urge the solvent through or relative to the BIP 10. Thus, according to various embodiments, any appropriate method may be used to move the solvent relative to the BIP 10.

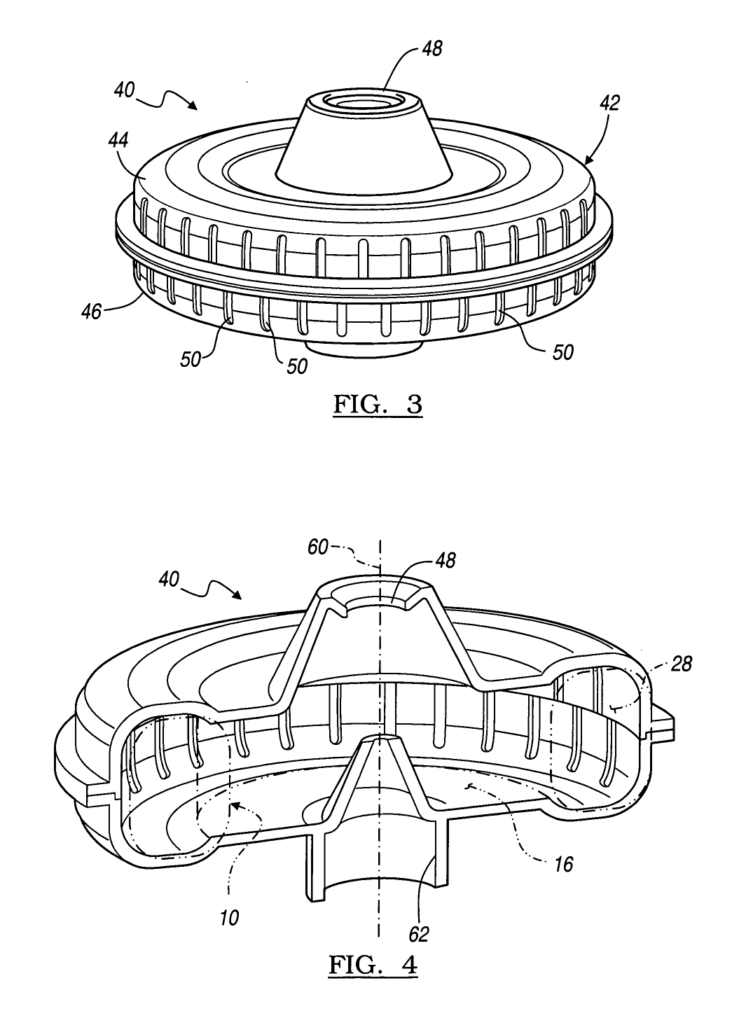

With reference to FIGS. 3 and 4, according to various embodiments, the BIP 10 may be provided in a cavity or beverage apparatus 40. The beverage apparatus 40 may include a structure 42 that may encase or enclose a selected portion of the BIP 10. For example, the beverage apparatus 40 may include an upper or first member 44 and a lower or second member 46. The two members 44, 46 may interlock or interact to substantially surround a majority of the BIP 10. The beverage apparatus 40 may further include a first solvent port 48. According to various embodiments, a plurality of second solvent ports 50 may be provided in a portion of the beverage apparatus 40. The solvent ports 48, 50 may allow the solvent to move form a first position to a second position relative to the BIP 10 in the beverage apparatus. According to various embodiments, the solvent may be introduced at the first solvent port 48, allowed to pass through the BIP 10, and exit the second solvent ports 50.

The beverage apparatus 40 may be used in any appropriate manner. For example, a solvent may be provided through the first solvent port 48 under a pressure greater than a pressure at the second solvent ports 50. Therefore, the solvent may be urged through the BIP 10 disposed in the beverage apparatus 40.

According to various embodiments, the second solvent ports 50 may be provided to allow an introduction of the solvent while the first solvent port 48 allows an exit of the solvent. The solvent may be provided to the outside wall 12, first, and pass to the internal void 16. Therefore, the solvent may be introduced through the second solvent ports 50 and passed through the BIP 10 and exit the first solvent port 48.

According to various embodiments, the beverage apparatus 40 may be allowed to move in a selected manner. For example, the beverage apparatus 40 may be formed to substantially spin about an axis 60. The axis 60 may define a generally central portion of the beverage apparatus 40. In addition, an axle or coupling member 62 may be positioned or extend from the beverage apparatus 40. The coupling member 62 may allow connection of a motor such that the beverage apparatus 40 may be spun or otherwise operated to move the beverage apparatus 40 in a selected manner.

According to various embodiments, a solvent may be passed through the first solvent port 48 and the beverage apparatus 40 may be spun to form a centrifugal force. The centrifugal force can urge the solvent introduced to the internal void 16 through the first port 48 from the internal void 16 through the BIP 10 and out the second solvent ports 50. In this manner, a beverage may be produced without providing the solvent at a pressure differential relative to any portion of the beverage apparatus 40. According to various embodiments, the pressure differential may be formed by movement of the beverage apparatus 40. The beverage apparatus 40, according to various embodiments, may be spun at various speeds or RPMs to achieve selected results, such as beverage formation time, strength, and other results. Various RPMs may be achieved by variable speed motors, differing sizes of the BIP 10, and various other features.

As discussed above, the surface area accessible by the solvent may be substantially altered depending upon various applications. Therefore, the surface area of the BIP 10 that may be engaged by the solvent may be any appropriate percentage of the surface area of the BIP 10. For example, the surface area, such as the surface area defined by the internal void 16, or the internal wall 14, may be about 20% to about 80% of the surface area of the BIP 10. According to various embodiments, the greater the surface area the greater the speed of movement of the solvent from a solvent inlet area to a solvent outlet. Depending upon the ingredient 30, or other material, in the void 28, the flow of the solvent may be reduced or increased. Nevertheless, the flow of the solvent to or through the BIP 10 may be altered by changing the surface area which the solvent may enter the BIP 10, the surface area that the solvent may exit the BIP 10, the attributes of the material 30 placed in the BIP 10, and other appropriate considerations. Therefore, the speed, efficiency and other factors may be altered when making a beverage with the BIP 10.

For example, the extraction process with a selected beverage ingredient, such as coffee, may be selected depending upon the type of beverage desired. For example, a substantially fast extraction may be desired for a selected type of coffee beverage, such as espresso. Alternatively, a slower extraction time may be selected for various other types of coffee beverage products. In addition, various beverage ingredients may be selected to include a different extraction time. Further, if a soluble product is the beverage ingredient 30, the extraction time may be selected to create a selected dilution or other appropriate function for the produced beverage.

In addition, it will be understood that the solvent may be any appropriate liquid. For example, water may be used as the solvent. Nevertheless, it will be understood that the solvent may be any appropriate component, such as an organic solvent, an alcohol, or any other appropriate solvent. It will be understood that the various solvents may be selected for various attributes and may depend upon the beverage ingredient 30. Furthermore, it will be understood that the solvent may be introduced into the BIP 10 at any appropriate temperature. It may be selected to provide the solvent through the BIP 10 at a selected temperature to achieve a selected result. For example, it may be selected to produce a coffee beverage at an elevated or above ambient temperature while a tea may be selected at an ambient temperature. Therefore, any appropriate temperature may be provided for the solvent.

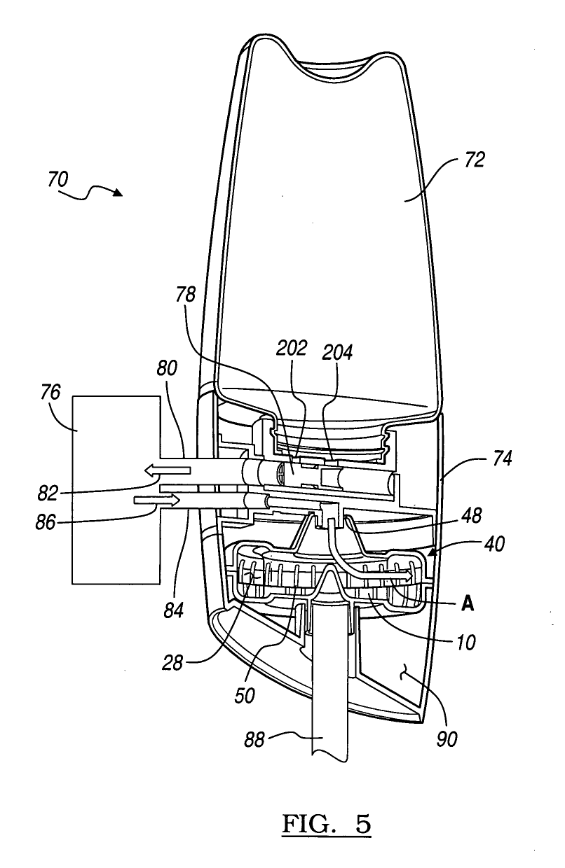

With reference to FIG. 5, a beverage container 70 may be formed to include and operate the beverage apparatus 40 that includes the BIP 10 in a selected manner. The beverage container 70 may include a first portion or solvent volume container (solvent container) 72 that is operable to hold the beverage solvent. It will be understood, however, that the solvent container 72 may be placed separately or removable from the beverage package 70. Nevertheless, interconnected with or fixed to the solvent container 72, may be a beverage forming portion or cap 74. The cap 74 may be interconnected with the solvent container 72 in any appropriate manner. For example, an interconnection via threads, interference fit, adhesive, welding, or the like may be used to associate or interconnect the cap 74 with the solvent container 72.

The beverage package 70 may be interconnected with any appropriate apparatus or appliance, such as the appliance 300 (FIG. 8), to allow for operation of the beverage package 70. Further, it will be understood that the beverage package 70 may be operated substantially independently of an external apparatus. Nevertheless, the beverage package 70 may be interconnected with a solvent heater 76 that is able to heat the solvent contained in the solvent container 72.

The solvent heater 76 may be any appropriate heater that is operable to heat the solvent at a selected rate. For example, the solvent may be substantially completely emptied into a selected volume or heated with a solvent heater that is surrounding the solvent container 72 such to heat the entire or substantially the entire volume of the solvent at a selected time. Further, or alternatively, the solvent may be heated at a selected flow rate through the solvent heater 76. Therefore, for example, it may be selected to heat the solvent at a selected rate, such as about one gallon per minute, for use in making a beverage. Regardless, the solvent heater 76 may be associated with the beverage package 70 in any appropriate manner such that the solvent contained in the solvent container 72 is heated to an appropriate temperature at an appropriate rate or time. Further, however, it may be understood that the solvent contained within the solvent container 72 need not be heated and may be transported from the solvent container 72 to a selected outlet.

When the solvent heater 76 may be used, however, the volume of solvent contained within the solvent container 72 may be passed through the solvent heater 76 to be heated at a selected rate. According to various embodiments, a valve member 78 may be operated to allow a volume of the solvent from the solvent container 72 to pass into a first channel or passage 80. The solvent is operable to flow generally in the direction of arrow 82 into and through the solvent heater 76. After the solvent reaches a selected temperature, the solvent may flow along a second passage 84 generally in the direction of arrow 86 to the first solvent port 48 in the beverage apparatus 40.

As discussed above, the solvent may pass through or move relative to the beverage apparatus 40 using centrifugal force formed by spinning the beverage apparatus 40 in a selected manner, such as with an axle 88. The axle 88 may be operated in any appropriate manner, such as with a selected motor or power providing device, such as one contained in the appliance 300. It will be understood that the motor may be any appropriate motor and is not limited to any particular kind of motor to operate the beverage apparatus 40. Nevertheless, as discussed above, the solvent may pass through the second passage 84 through the solvent port 48 and move generally in the direction of arrow A and out through the second solvent port 50.

As discussed above, the solvent that may mix with the ingredient 30 positioned within the void 28 of the BIP 10. The solvent may pass through the second solvent port 50 to a collection area or volume 90. Also, the solvent may flow due to any appropriate urging, such as gravity, pressure differences, mechanical forces, or the like. The collection volume 90 may be formed as a portion of the cap 74 or may be any appropriate container, such as removable or transportable cup for use by a user. Nevertheless, the solvent is operable to be removed from the beverage apparatus 40 for use by a user.

Therefore, the beverage package 70 may be used to form a beverage by providing the beverage apparatus 40 to be operated with the axle or mechanism 88. The axle 88 may rotate the beverage apparatus 40 to form a centrifugal force to move a solvent generally in the direction of arrow A through the second solvent port 50 for collection in a selected container. The solvent may either be heated with the solvent heater 76 or not heated according to selected or various embodiments. In addition, the solvent heater 76 may be a separate solvent heater mechanism or may be incorporated in the solvent volume container 72. For example, the solvent heater 76 may be a separate heatable container or area. Alternatively, or in addition to a separate heater, the solvent heater 76 may include resistive portions positioned relative or adjacent to the solvent container 72 to heat the volume of solvent in the solvent container 72 at an appropriate time.

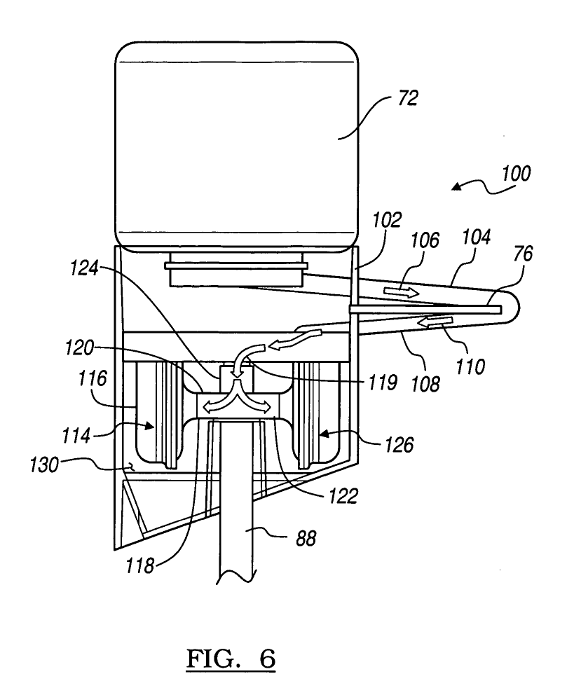

With reference to FIG. 6, where like reference numerals reference like portions, a beverage package 100 according to various embodiments is illustrated. As discussed above, a solvent container 72 may be associated with the beverage package 100 or may be separate therefrom. Nevertheless, the beverage package 100 may include a beverage ingredient container or cap 102 that may be associated with the solvent container 72 in any appropriate manner, such as those discussed above.

The solvent may move from the solvent container 72 through a first passage 104, along or generally in the direction of arrow 106, similar to the first passage described above. The solvent moving through the first passage 104 may be moved to or moved relative to the solvent heater 76. As discussed above, the solvent heater 76 may be any appropriate solvent heater such as one that is operable to heat the solvent at a selected rate or heat the solvent at a selected time. Regardless, the solvent is operable to move through the first passage 104 and through a second passage 108 generally in a direction of arrow 110 to be moved towards the cap or beverage ingredient container area 102.

Positioned within the cap 102 is a beverage ingredient package (BIP) 114. The BIP 114 may be any appropriate package such as pod filter package. The pod filter package may include an external filter or permeable portion 116 that is operable to allow the solvent to pass through the outer filter portion 116 while maintaining an ingredient within the BIP 114.

It will be understood that the beverage ingredient pod 114 may be formed similar to the BIP 10 as discussed above, yet in a different shape, size, geometry, configuration, or the like. For example, the BIP 114 may be substantially cylindrical such that it does not include an open area or a toroid shape. It will be understood that the BIP 114, however, may be formed in any appropriate manner.

The BIP 114 contained within the cap 102, however, may be interconnected with a mechanism, such as a solvent transport system 118. The BIP 114 may be held relative to the solvent transport system 118 with any appropriate means. For example a generally porous cap may be placed over or interconnecting the BIP 114 with the solvent transport system 118. Also the BIP 114 may otherwise be fixed to the beverage transport system 118.

The solvent transport system 118 may include substantially hollow or passage portions or manifolds 120, 122. The manifolds 120, 122 may interconnect with the second passage 108 through a main passage 124 such that the solvent may move from the solvent container 72 to the BIP 114 and a second BIP 126, which also may be appropriately held relative to the solvent transport system 118. It will be understood that any appropriate number of the BIPs 114, 126 may be included and two are illustrated for simplicity and efficiency of the present discussion. Nevertheless, only one, two or more BIPs, or any appropriate number of BIPs may be included. For example, two BIPs 114, 126 may be formed at a substantially similar weight or density such that the mass of each offsets the other to allow for an efficient and easy rotation of the pods 114, 126 within the cap 102.

As discussed above, the mechanism 88 may be provided to operate a portion of the cap 102 such as spinning or forming a centrifugal force within the solvent transport apparatus 118. Therefore, the solvent may pass from the second passage 108 generally in the direction of arrow 110 and further in the direction of arrow 119 through the two manifolds 120, 122 and through the BIPs 114, 126. The centrifugal force formed by the interaction of the mechanism 88 with the solvent transport mechanism 118 may force or urge the solvent to pass through the BIPs 114, 126. As the solvent passes through the BIPs it is able to dissolve, extract, or the like any appropriate ingredient included within the beverage ingredient packages 114, 126. Nevertheless, as discussed above, any force may be used to urge a movement of the solvent, such as gravity, a pressure differential, etc.

The BIPs 114, 126, similar to the BIP 10, may include any appropriate beverage ingredient, such as coffee, tea, soluble products, and the like. Therefore, the solvent may pass through the BIP 114, 126 to form a formed beverage. The formed beverage may then be collected in a collection volume or area 130 defined by a portion of the cap 102 or in a container or cup operable to be used by a user.

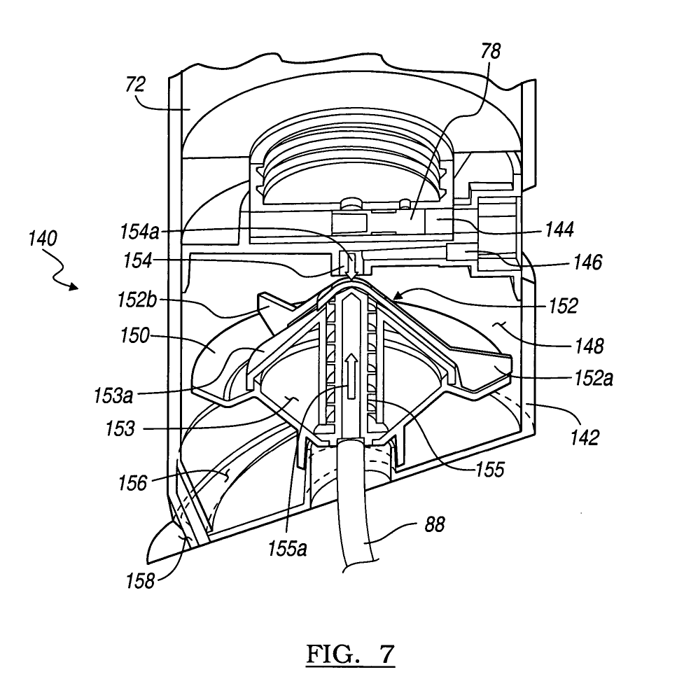

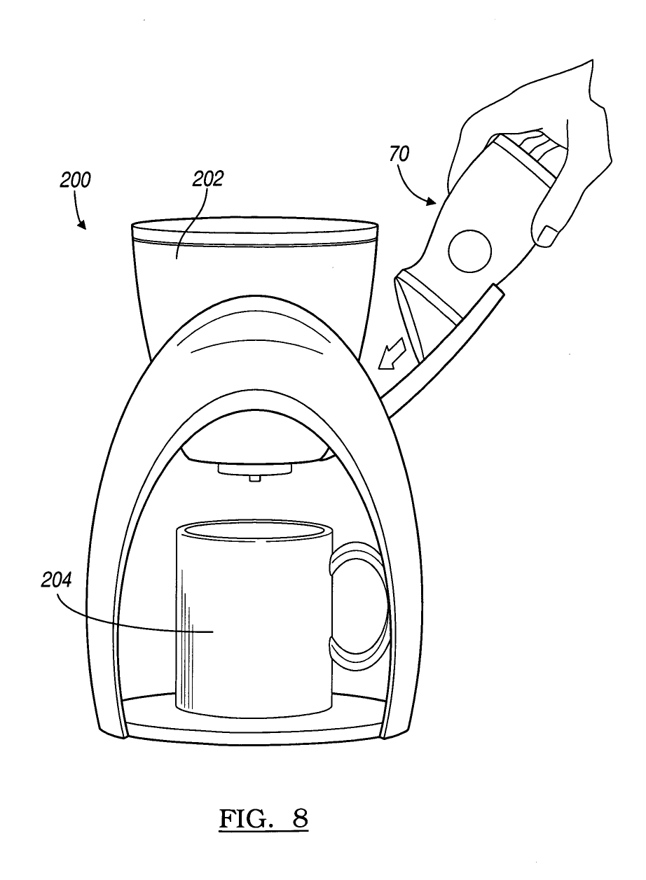

With reference to FIG. 7 a beverage container 140, according to various embodiments, is illustrated. The beverage container 140 may include the solvent container 72, or a solvent supply may be provided separate from the beverage container 140. The beverage container 140 may also include a cap or beverage forming/ingredient portion 142. A first passage 144 may direct the flow of the solvent in a first direction and a second passage direction the flow of the solvent in a second direction, such as towards a forming area 148. As discussed above a valve mechanism 78 may be provided to control a flow of solvent from the solvent container 72 to the forming area 148.

The valve mechanism 78 may generally be held within a portion defined by the solvent container 72. As discussed above, the solvent container 72 need not be fixed to the cap 74, thus various portions of the beverage container may be combined in the solvent container 72 alone. Thus the valve mechanism 78, or any appropriate mechanism to selectively gain access to the solvent, may be provided with the solvent container 72. It will be further understood, as discussed herein, that the solvent container need not be provided and a different source of solvent may be provided.

In the forming area a mixing tray or area 150 may be provided. The tray 150 may be formed in any appropriate manner to contain or orient a beverage ingredient and the solvent. In conjunction with the tray 150 a mixing apparatus 152 may also be provided. The mixing apparatus 152 may include a first arm 152a and a second arm 152b. The arms 152a, 152b, may include portions that are shaped and/or sized substantially complimentary to the tray 150. Thus the arms 152a, 152b may move relative to the tray 150 to agitate or mix the beverage ingredient with the solvent provided to the forming area 148.

Positioned near the tray 150 is a beverage ingredient area or package (BIP) 153. A beverage ingredient may be positioned in the BIP 153 and may any appropriate ingredient. For example a substantially soluble beverage ingredient may be positioned in the BIP 153. The BIP 153 may be operated, as described herein, to provide the beverage ingredient to the tray 150 for a brief and efficient mixing of a solvent or fluid with the solvent for forming the final beverage.

Also an auger or metering mechanism 155 may be provided in or near the BIP 153. The metering mechanism 155 may operate to move a selected volume or mass of the beverage ingredient from the BIP 153 to the tray 150. The metering mechanism may move the beverage ingredient in the direction of arrow 155a towards a surface 153a of the BIP 153. The metering mechanism 155 may be any appropriate mechanism, such as a screw, conveyor, lift, etc.

As discussed above the solvent may move into the forming area 148 in any appropriate manner, such as with a pressure differential, gravity, etc. Regardless, the solvent may flow through the second passage 146 to a solvent port or forming area inlet 154. The solvent may flow or move generally in the direction of arrow 154a. As the solvent moves in the direction of arrow 154a the solvent is urged into or towards the tray 150. Thus the solvent may mix with the beverage ingredient. The mixing and the mixing rate may be augmented with the mixer 152.

The mechanism 88 may power both the metering mechanism 155 and the mixer 152. The metering mechanism 155, at a selected time and according to various embodiments, may move a selected amount at a selected rate of the beverage ingredient to the tray 150. Once the ingredient is moved out of the BIP 153 it may begin mixing with the solvent from the solvent inlet 154. The mixer 152 may also assist in mixing the beverage ingredient with the solvent as the two move over the surface 153a and towards the tray 150.

Once a selected amount of mixing occurs the solvent, including the suspended or dissolved beverage ingredient, may be urged out of the tray into a collection area 156. The solvent may be urged out of the tray 150 in any appropriate manner. For example, the mixer 152 may be operated to move the solvent out of the tray 150. Once in the collection area the formed beverage may exit a spout or port 158.

According to various embodiments the beverage container 140 may be moved to urge the solvent out of the tray 150. For example, the beverage container may be tilted. Alternatively, or in addition to tilting, the mixer 152 may be increased in velocity to urge the solvent form the tray 150. A first velocity may be used to mix the solvent with the beverage ingredient while a second speed may be used to urge the solvent from the tray 150.

The mixer may be powered or moved with the axle 88 or any appropriate mechanism. For example the mixer 152 may be associated with the metering mechanism 155 that interconnects with the axle 88 that may move the mixer 152. Therefore, it will be understood that the mixer 152 may be operated in any appropriate manner.

It will be understood that any appropriate configuration may be provided to allow for a beverage to be formed using a centrifugal or other appropriate force. The beverage apparatus 40 may be used or any other appropriate beverage apparatuses, such as the solvent transport system 118 and the BIPs 114, 126 to form a beverage by moving a solvent through a BIP 110, 114, 126. Also the tray 150 and mixer 152 may be used to assist in forming a beverage. Also, as discussed above, any appropriate number of beverage containers 70, 100, 140 may be used in conjunction with BIPs, according to various embodiments.

Also, according to various embodiments a separate or distinct BIP may not be necessary. For example a porous member that may act as a filter may be provided relative to a solvent moving system. A beverage ingredient may be contained in a substantially impermeable container including only a portion defined by a porous member. A solvent may be urged towards the porous portion, such as by a centrifugal force, to pass through a beverage ingredient. Therefore, a BIP, will be understood, to not be necessary to form a beverage, according to various embodiments.

It will be further understood, that the beverage container may be provided as a plurality of beverage container based upon a selected augment ingredient. For example, a varying insensitive of sweetness may be provided such that a plurality of beverages containers may be marked and provided at a varying level of sweetness.

Further, it will be understood that various other components may be provided relative to the beverage ingredient package. For example, various creamer portions, sweetener portions and the like may be positioned relative to the beverage ingredient pod or beverage ingredient area such that as the solvent passes through or is urged toward the beverage ingredient, the solvent may also dissolve or extract a selected ingredient, such as a sweetener or a creamer. The sweetener or creamer pod may be positioned in sequence with the beverage ingredient pod to allow for an extraction of both the beverage ingredient and the augmented ingredient. Thus, the beverage container, according to various embodiments, may be used to extract or dissolve both a beverage and augment the beverage with a selected ingredient.

Further, various ingredients, such as fortifiers, including vitamins, minerals, and other health-related ingredients, may be provided in conjunction with the beverage. The beverage container may be provided with a separate container or pod portion including a selected fortifying ingredient, such as a selected vitamin or mineral. Therefore, as the solvent dissolves or extracts a selected ingredient for a beverage, the fortifying ingredient may also be dissolved or extracted into the formed beverage. Therefore, the beverage container may be provided with the solvent volume, a beverage ingredient, and a beverage augment ingredient, such as a sweetener, creamery, fortifier (i.e., vitamins and/or minerals).

Therefore, for example, with reference to the beverage container 70, a soluble portion, such as a solvent soluble caplet or capsule, may be positioned in the beverage apparatus 40. As the solvent passes through the solvent port 48, the solvent may engage the fortifying caplet or augment ingredient to carry at least a portion of the augment ingredient through the BIP 10 and into the formed beverage. Alternatively, the augment ingredient may be positioned into the collection area 90 of the cap 74 such that after the solvent passes through the BIP 10, the partially formed beverage may mix with the augment ingredient to form the formed beverage. According to various embodiments, the augment ingredient may also be added loose with the solvent or to pass through the first port 48. Thus, the augment ingredient may be provided in any appropriate manner. Regardless of a position of the augment ingredient, it will be understood that the augment ingredient may be positioned relative to the beverage container 70, according to various embodiments, such that as a beverage is being formed, the augment ingredient may be added to the beverage.

Further, the beverage package 70 may be provided as a plurality of beverage packages each including a varied or plurality of augment ingredients. For example, a first of the beverage packages 70 may be provided as plurality of beverage packages including a varying intensity of sweetness. Thus, a user may be allowed to select a selected beverage container according to a sweetness level to provide a selected sweetness of a final beverage product. Similarly, the augment ingredient may be the fortifying ingredient such that the beverage container 70 may be selected for the inclusion or deletion of the fortifying ingredient. Thus, the beverage package 70 may be provided to allow for a user selection of a final beverage including a selected augment ingredient.

The augment ingredient may further be provided at any appropriate time. For example, in a coffee beverage ingredient, coffee beans or cherries are often first roasted before being ground to form coffee grounds. After the cherries are roasted, they include or may have formed therein a selected porosity in which a selected augment ingredient may be provided. Therefore, a fortifying ingredient, such as a selected vitamin or mineral, may be mixed with the roasted coffee beans to form a fortified coffee bean which may then be ground to include the fortifying ingredient. The fortifying or augment ingredient may be provided in any appropriate manner, such as a liquid, to the roasted bean. Various fortifying ingredients may include selected minerals, such as calcium or zinc, or various vitamins such as Vitamin A or B. Regardless, the fortifying ingredient may be added to the coffee beans after they are roasted such that the fortifying ingredient is at least partially intermingled with the coffee beans or included in the porosity formed in the coffee beans. In this manner the fortifying ingredient is provided in the beverage ingredient which may be positioned in the BIP 10.

It will be understood that an augment ingredient, such as a flavoring or a fortifying ingredient, may be included in the beverage container 70, according to various embodiments, or any appropriate beverage container with any appropriate beverage ingredient. The inclusion of an augment ingredient is not limited to any particular beverage ingredient and may be provided in any appropriate beverage ingredient or any appropriate beverage container to form a final beverage product.

Further, it will be understood that the augment ingredient may be added to the beverage container 70, according to various embodiments, at any appropriate time. Therefore, the beverage container 70 may be formed to include one or a plurality of the augment ingredients with a single or plurality of beverage ingredients. As discussed above, the beverage container 70, according to various embodiments, may include one or a plurality of augment ingredients that vary between a selected plurality of beverage containers. Further, it will be understood that the augment ingredient may be provided in any appropriate form such as substantially fluid form, a dry form, or any appropriate form.

The beverage package 10, according to various embodiments, may be formed with the beverage container 70, according to various embodiments, to be positioned in a selected apparatus or appliance 300, such as that exemplary illustrated in FIG. 8. The beverage appliance 300 may include any appropriate portion to receive or interact with the beverage container 70. For example, the beverage appliance 300 may include a containment region 302 to substantially surround or receive the beverage container 70. Regardless, it will be understood that the appliance 300 may also include a small recess, clip, or other appropriate portion to allow for a selected interaction between the beverage container 70 and the appliance 300. Therefore, the appliance 300 will be understood to substantially receive and surround the beverage package 70 or efficiently interact with the beverage package 70 for formation of a beverage product.

Further, the appliance 300 may provide or interact with the mechanism 88 to engage the beverage apparatus 40 to form the centrifugal force. The appliance 300 may also provide or include the solvent heater 76 such that the appliance 300 may heat the solvent to a selected temperature. Therefore, the appliance 300 may include a motor operable to move the mechanism 88 to form the centrifugal force and an electrical source to form or activate the solvent heater 76. Further, the motor may be, but is not limited to, electrically powered to form the centrifugal force. It will be understood that any appropriate power source may be used, such as battery, pneumatic, steam, etc. It will be understood that the design of the appliance 300 is not limited and may be any appropriate design to interact with the beverage package according to various embodiments, as discussed above. Also, the appliance 300 may include portions to allow a user to efficiently operate the appliance 300 to interact with the beverage container 70, according to various embodiments, to form a beverage.

With reference to FIGS. 5 and 8, the appliance 300 may also include a portion to manipulate the valve mechanism 78. The appliance 300 may include a member operable to pierce the cap 74 to engage the valve mechanism 78. Also the appliance may only move relative to the valve member 78 to engage the valve mechanism 78.

The valve mechanism 78 may be moved such that a first port 202 may allow for a selected volume of the solvent contained in the solvent container 72 to pass to the solvent heater 76 or to the solvent inlet 48. A second port 204 may be provided for any appropriate purpose, such as venting the container 72 to allow for a pressure differential or relief of pressure in the container 72 to allow the solvent to continue to drain from the solvent container 72. Regardless, the valve mechanism 78 may be operated by the appliance 300, or any appropriate mechanism, to allow for removal of the solvent from the solvent container 72 to form the beverage.

Further, the appliance 300, or any appropriate mechanism, may provide for a selected venting of the solvent container 72 to allow for a selected release or flow of the solvent from the solvent container 72. For example, a substantially positive pressure venting may be formed to allow for effective and/or efficient removal of the solvent from the solvent container 72. For example, as the solvent is exiting the solvent container 72, the solvent container 72 may be filled with a fluid or material at a pressure higher than atmospheric pressure or ambient pressure such that the solvent continues to drain from the solvent container 72 at its selected rate. Any appropriate mechanism may be provided, such as a pump provided in the appliance 300, to provide a positive or higher pressure to the solvent container 72, than the ambient pressure.

Further, a natural aspiration of the solvent container 72 may be provided. For example, as the valve mechanism 78 is moved, the second port 204 may communicate with an ambient atmosphere. This communication may allow the solvent container 72 to be aspirated in a selected manner so that the solvent contained in a solvent container 70 may flow from the solvent container 72 at a selected rate. Further, the solvent container 72 may be otherwise opened or pierced in a selected area to provide for a natural or ambient aspiration of the solvent container 72 when removing the solvent from the solvent container 72.

Further, the solvent container 72 may include a collapsible portion such that the solvent volume removed is also effectively removed from the container 72. The container 72 may be completely collapsible or may include an inner lining that is collapsible or flexible. Therefore, as the solvent is removed from the solvent container 72, the solvent container 72 or an internal liner substantially surrounding the solvent, may collapse to reduce a volume of the solvent container 72. Therefore, the solvent may be remove from the solvent container 72 in a selected manner. This may reduce or eliminate a vacuum that may otherwise be created in the solvent container 72 as the solvent is removed therefrom.

Regardless, it will be understood that the solvent may be assisted in being removed from the solvent container 72 in any appropriate manner. As discussed above, a positive pressure may be provided, and/or a natural aspiration may be provided, or a void or volume reduction may be provided in the beverage container 72. Further, a plurality of mechanisms may be provided to vent or assist in removing the solvent from the solvent container 72. Further, the appliance 300 may provide the mechanism to assist in removing the solvent. Alternatively, the solvent container may include the mechanism to assist in removing the solvent from the solvent container 72 and/or venting the solvent container 72. Regardless, it will be understood that the solvent may be removed from the solvent container 72 in a selected manner to assist in moving the solvent to the cap 74 or any appropriate portion to form the beverage. Also, it will be understood that various venting mechanisms may be provided to in any appropriate beverage container.

Further, as discussed above, it will be understood that the beverage container 70 may be provided to substantially include the cap portion 74. Therefore, rather than the beverage container 70 including both a solvent container 72 and a cap 74, the beverage container 70 may include simply or substantially only the cap 74. For example, the cap 74 may be associated with the appliance 300 and the appliance 300 may include a mechanism to provide a selected volume of a solvent to the cap portion 74 to form a selected beverage. Thus, the beverage container 70 need not include a selected volume of a solvent and may include substantially only a beverage ingredient and/or the beverage apparatus 40, or any beverage apparatus according to various embodiments, to assist in forming a beverage.

The beverage container 40, 70, 100, and 140 according to various embodiments may provide a generally self-contained beverage forming mechanism. The solvent and beverage ingredient may be provided as a generally single mechanism, or individually. Regardless, the beverage container may provide that the finished beverage may exit directly from the beverage container into a user-container 304. Thus, the finished beverage may be provided in an efficient manner with less possibility for contamination and may include a greater freshness and cleaner taste for a user.

Further, the beverage apparatus or the BIP, according to various embodiments, may be operated to achieve selected results. For example the rate of rotation may be increased to decrease the time to form a beverage. Also the rate of rotation may be altered to achieve a selected brew or beverage formation time depending upon the beverage ingredient. Also, other forces may be altered, such as the pressure differential across the BIP and the like. Thus, it will be understood, that various characteristics of operation or a beverage may be selected depending upon a force provided relative to the BIP.

It will be understood that various items may be used as beverage ingredients, as discussed herein, and various other similar or difference items may be used as a solvent, as discussed herein. Thus, for example and not limiting, a beverage ingredient may include coffee, coffee grounds, tea leaves, dehydrated coffee, and others. Also a solvent, for example and limited to, may include water, alcohol, corn syrup, and others.

The description of the teachings is merely exemplary in nature and, thus, variations that do not depart from the gist of the teachings are intended to be within the scope of the teachings. Such variations are not to be regarded as a departure from the spirit and scope of the teachings.

What is claimed is:

1. A beverage package for use in a beverage apparatus, comprising:
a first surface substantially porous to a material; and
a second surface substantially porous to the material;
said first surface and said second surface define a void operable to at least partially surround a material.

2. The beverage package of claim 1, wherein said first surface and said second surface generally define a toroid including and outer wall and an inner wall.

3. The beverage package of claim 2, wherein said inner wall generally defines the void.

4. The beverage package of claim 1, further comprising:
a beverage apparatus substantially complimentary in geometry to at least one of said first surface or said second surface.

5. The beverage package of claim 4, wherein said beverage apparatus defines an inlet and an outlet.

6. A method of forming a beverage with a beverage package generally defining a toroid including an inner wall defining an internal void, and an outer wall, the method comprising:
positioning a solvent near the internal void; and
creating a centrifugal force relative to the beverage package to urge the solvent form the internal void through the beverage package.

7. The method of claim 6, further comprising:
providing an ingredient in the beverage package; and
extracting a material from the ingredient.

8. The method of claim 7, wherein extracting the material includes forming a force to urge the solvent through the beverage package.

9. The method of claim 8, wherein forming the force includes spinning the beverage package.

10. A beverage package, comprising:
an inlet area;
an outlet area; and
an ingredient area.

11. The beverage package of claim 10, wherein said inlet area is a first portion of a toroid and said outlet area is a second area of the toroid.

12. The beverage package of claim 11, wherein said first portion is an internal void.

13. The beverage package of claim 10, wherein said ingredient area is an area between said inlet area and said outlet area.

14. The beverage package of claim 10, wherein said inlet are and said outlet are defined by a porous material.

15. A method of providing an augment ingredient to a roasted coffee bean, comprising:
roasting a coffee bean;
adding the augment ingredient to a volume of the roasted coffee beans; and
forming a ground coffee including the augment ingredient.

16. The method of claim 15, wherein the augment ingredient includes a vitamin.

17. The method of claim 15, wherein the augment ingredient includes a bio-active mineral.

18. A beverage apparatus, comprising:
a forming area including a beverage ingredient storage area to hold a volume of a beverage ingredient;
a mechanism to move a selected volume of said beverage ingredient to a mixing area; and
a mixer to mix the selected volume of the beverage ingredient with a solvent.
